(19) United States
(12) Patent Application Publication
(10) Pub. No.: US 2007/0174397 A1
(43) Pub. Date: Jul. 26, 2007

(54) Electronic networking and notification system

(75) Inventor: Joseph E. David, Lake Havasu City, AZ (US)

Correspondence Address: WEISS & MOY PC, 4204 NORTH BROWN AVENUE, SCOTTSDALE, AZ, 85251, US

(73) Assignee: BLACK ASPHALT, INC.

(21) Appl. No.: 11/339,220

(22) Filed: Jan. 25, 2006

(51) Int. Cl. G06F 15/16; G08B 29/00; G08B 1/00

(52) U.S. Cl. 709/206; 340/506; 340/531

(57) ABSTRACT

An electronic system and method for networking and notification that permits a law enforcement officer from a first agency to obtain database information relating to a law enforcement seizure from databases belonging to other agencies. Such access is facilitated by a web-site maintained at a notification server, which acts as a hub between, on the one hand, notifying devices that may be operated by law enforcement agents in the fields, and agency devices, that may be operated by agencies having access to searchable databases.

### FIELD OF THE INVENTION

The present invention relates generally to an electronic system and method for networking and notification and, more particularly, to a system and method that utilizes a network of law enforcement related agencies to effectively transmit and obtain information regarding law enforcement matters.

### BACKGROUND OF THE INVENTION

A significant law enforcement problem is the failure to sufficiently share information between and among law enforcement agencies. It is estimated that only about 25% of seizures of suspects and/or property are reported to any database. In addition, when seizure reports are made, these do not necessarily occur to multiple agencies with access to different databases. In situations where there is insufficient reporting and searching of databases, valuable investigation opportunities may be lost.

There are a variety of reasons for these reporting deficiencies. Often, inter-agency reporting can be time-consuming and inconvenient, making it difficult to do in practice. The lack of ready, real-time reporting can mean that, even where a report is made and useful information obtained, that information may come too late to assist an officer in the field.

The present invention is concerned with providing a law enforcement agent in the field with real-time access to agencies that maintain relevant databases, to exchange information concerning suspects and/or seized property, and to thereby obtain the benefits that may come from such real-time, inter-agency cooperation. In certain of its aspects, this invention provides a vehicle for interagency notification, permits the posting of seizure information, provides notification to follow-up investigators concerning a seizure, and provides other beneficial features.

### SUMMARY OF THE INVENTION

In accordance with an embodiment of the present invention, an electronic networking and notification system is disclosed. The system comprises: a plurality of officer devices; a web-site hosted on a notification server; wherein the officer devices are in networked communication with the notification server so that a user of one of the officer devices may access the web-site; a plurality of agency devices in networked communication with the notification server; wherein the plurality of agency devices belong to at least two different agencies; and at least two searchable law enforcement databases; wherein the searchable law enforcement databases belong to the two different agencies.

In accordance with another embodiment of the present invention, a method for exchanging law enforcement related information is disclosed. The method comprises: communicating via an officer device with a notification server; accessing on the officer device a web-site hosted on the notification server; inputting information at the web-site, utilizing the officer device, regarding a seizure; selecting at least two agencies to whom the information is to be communicated from the notification server to the agency devices in networked communication with the notification server; wherein the plurality of agency devices belong to at least two different agencies, each of which has at least one searchable law enforcement database; receiving on the officer device information from the at least one searchable law enforcement database.

In accordance with a further embodiment of the present invention, a method for exchanging law enforcement related information is disclosed. The method comprises: providing a web-site hosted on a notification server; facilitating networked communication between the notification server, a plurality of officer devices, and a plurality of agency devices; wherein the plurality of agency devices belong to at least two different agencies, each of which has at least one searchable law enforcement database; facilitating accessing on the officer device a web-site hosted on the notification server; facilitating inputting of information at the web-site, utilizing the officer device, regarding a seizure; facilitating selection of at least two agencies to whom the information is to be communicated from the notification server to the agency devices in networked communication with the notification server; facilitating receipt on the officer device of information from the at least one searchable law enforcement database.

### BRIEF DESCRIPTION OF THE DRAWINGS

FIG. 1 is a block diagram, illustrating components of a system consistent with an embodiment of the present invention.

FIG. 2 is a flow chart, illustrating steps in the performance of a method consistent with an embodiment of the present invention.

### DETAILED DESCRIPTION OF THE PREFERRED EMBODIMENTS

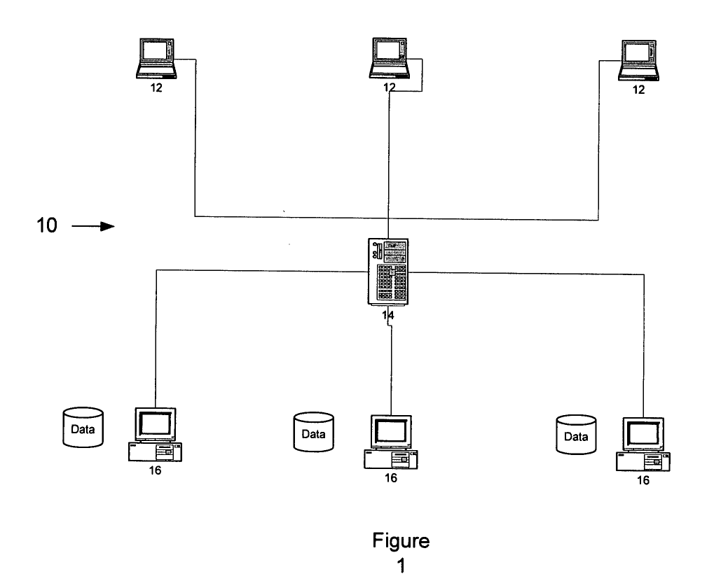

Referring first to FIG. 1, a system 10 consistent with an embodiment of the present invention is illustrated. In this embodiment, a notifying officer utilizing a notifying officer communication device 12 (“officer device 12”) obtains information regarding a seizure of a person and/or property (herein a “seizure”). The notifying officer may be a field officer. The officer device 12 is a networked communication device, such as a portable computer, PDA, or other device. Such a device may be maintained, for example, in a patrol car, or it may be of a handheld, portable type.

As shown in FIG. 1, it is contemplated that there would be a plurality of officer devices 12. It is further contemplated that certain of the officer devices 12 will be utilized by notifying officers from different agencies.

The officer devices 12 are in networked communication with networking and notification server 14 (“notification server 14”). Preferably, the officer devices 12 may directly communicate with the notification server 14 by, for example, logging in to a web-site hosted at the notification server 14.

The notification server 14 is in networked communication with a plurality of agency devices 16. The agency devices 16 may be any type of network-capable computing device, including for example a desktop or laptop personal computer. The agency devices 16 may be utilized by other law enforcement or other agencies, to which it may be desired to report information concerning a seizure. Some and perhaps all of the agencies may themselves maintain databases of information concerning criminal suspects and the like. One or more of the agency devices 16 may be in electronic communication with such one or more databases maintained by such agency. Certain of the agencies may be ones to whom the agency employing the notifying officer has an interagency reporting obligation. In response to such a notification, and following for example a database search, a communication may be sent from an agency device 16 to an officer device 12 (whether directly or via notification server 14) regarding information pertinent to the seizure.

Initially, it should be noted, that the notification server 14 should have secured access. That may require a logging on to the web-site maintained on the notification server 14, such as through the inputting of a registered username and password. There may, in addition, be levels of permitted access at the web-site. For example, there may be an “all access” section of the site, into which seizure information may be entered, without the person entering such information having the ability to benefit from information that may be contained in an agency database. There may be a “members only” section, in which a notifying officer may be able to gain access to agency databases. Other features on the web-site, as herein described by way of example, may be assigned these or different access levels.

A web-site operated on the notification server 14, and accessed by a notifying officer via officer device 12, may have a number of features. For example, it may permit notifying officers to submit a seizure to one or more agency devices 16. The purpose of such reporting may be to permit the notifying officer to benefit from information contained in an agency database. The purpose may be, in addition or in the alternative, to fulfill an inter-agency reporting obligation.

Another purpose may be to notify an agency concerning a seizure, relating to which the agency receiving such notification may wish to perform follow-up investigation. For example, an arrest of a resident of Arizona in the state of California may trigger a communication from a California notifying officer to an agency device maintained by an Arizona law enforcement agency, so that the Arizona agency can have the ability to perform a follow-up concerning its resident. Such follow up may include search warrants, knock and talks, and the like.

The web-site at the notification server 14 may have a bulletin board type of area where a variety of information relevant to law enforcement may be displayed. This may include posts of seizures. There may be one or more message boards, which may provide a forum for officers to communicate with each other regarding matters of shared interest, to share lookouts, etc.

The web-site may contain a vehicle concealment database, which can provide officers with a central database for known vehicle concealment areas for specific makes, models, and years of vehicles. The site may further display case law relevant to field criminal interdiction from federal and perhaps also state courts. The web-site may provide the ability for the submission of new case law by an authorized person. The web-site may contain relevant law enforcement bulletins, such as those related to narcotics, homeland security, officer safety, or other areas of interest to law enforcement.

The web-site may further contain a member directory, listing members. Such listing may include contact information for members, including for example telephone and fax numbers, physical addresses, and email addresses. The site may facilitate the logging on by a member to the site for purposes of editing the member's directory information.

Preferably, the web-site includes a search engine, to permit a search of web-site content.

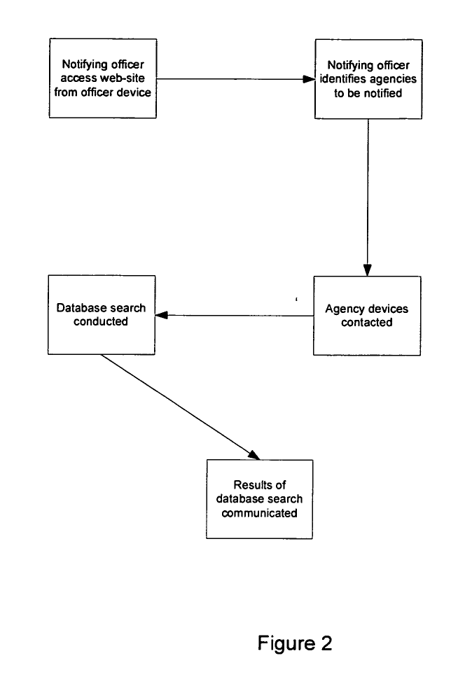

Referring now to FIG. 2, steps of a method consistent with a method of the present invention are shown. A notifying officer utilizes an officer device 12 to obtain access to a web-site located at the notification server 14. In order to access the site, the officer may be required to log on, perhaps through inputting of a username and password. It should be noted that the log on process may be automated, with the notification server 14 being able to automatically determine, through an electronic signature or the like, that the officer device 12 is a secure device with a right of access.

A notifying officer seeking to notify a plurality of agency devices 16 concerning a seizure may do so at the web-site on the notification server 14. The agencies corresponding to the agency devices 16 may be pre-selected by the notifying officer prior to the notification for a particular seizure so that, for example, every seizure is communicated to a pre-selected group of agency devices 16. Alternatively, the notifying officer may be prompted, for each seizure, to select the agencies to which notification shall be made.

Agencies who have received notification of a seizure via agency device 16 may conduct a database search relating to the seizure. Information obtained as a result of such a search may be communicated via agency device 16 to the notification server 14 and/or officer device 12. In addition, the agency receiving such notification may wish to provide notification to other agency personnel, including but not limited to field personnel, regarding the seizure and/or results of the database search. Such notification may occur via agency device 16 or utilizing other hardware, and may include email notification, pager notification, phone notification, or other modes of notification.

An embodiment of the system and method of the present invention has been in operation for a period of months, and results have been impressive. From Mar. 10, 2005 through Dec. 13, 2005, there were 716 entries into the web-site located at the notification server 14. These have resulted in the seizure of

61,457 Pounds of Marijuana

6,721 Pounds of Cocaine (Powder)

3 Pounds of Cocaine (Crack)

77 Pounds of Methamphetamine

2 Kilograms of Methamphetamine

337 Pounds of Crystal Methamphetamine (ICE)

30 Pounds of Heroin

13 Pounds of Mushrooms

138 Pounds of Ecstasy

11,915 Tablets of Ecstasy

0.50 Pound of Hashish

0.44 Pound of Ephedrine/Pseudoephederine

4 Gallons of PCP

1,539 Tablets of Other Type of Illegal Tablet(s)

1 Pound of Other Type of Illegal Powder(s)

0.90 Gallon of Other Type of Illegal Liquid(s)

72 Weapons

$38,127,889.67 Dollars in US Currency

While the invention has been particularly shown and described with reference to preferred embodiments thereof, it will be understood by those skilled in the art that the foregoing and other changes in form and details may be made therein without departing from the spirit and scope of the invention.

I claim:

1. An electronic networking and notification system comprising:
a plurality of officer devices;
a web-site hosted on a notification server;
wherein the officer devices are in networked communication with the notification server so that a user of one of the officer devices may access the web-site;
a plurality of agency devices in networked communication with the notification server;
wherein the plurality of agency devices belong to at least two different agencies; and
at least two searchable law enforcement databases;
wherein the searchable law enforcement databases belong to the two different agencies.

2. The system of claim 1 wherein the web-site includes a bulletin board for posting of information relevant to law enforcement.

3. The system of claim 1 wherein the web-site includes a vehicle concealment database, containg information for known vehicle concealment areas.

4. The system of claim 1 wherein the web-site includes a display of law enforcement related case law.

5. The system of claim 1 wherein the web-site includes law enforcement bulletins.

6. The system of claim 1 wherein the web-site includes a member directory.

7. The system of claim 1 wherein the web-site has at least one area of restricted access.

8. The system of claim 1 wherein the web-site includes a search engine adapted to permit a search of content on the web-site.

9. A method for exchanging law enforcement related information comprising:
communicating via an officer device with a notification server;
accessing on the officer device a web-site hosted on the notification server;
inputting information at the web-site, utilizing the officer device, regarding a seizure;
selecting at least two agencies to whom the information is to be communicated from the notification server to the agency devices in networked communication with the notification server;
wherein the plurality of agency devices belong to at least two different agencies, each of which has at least one searchable law enforcement database;
receiving on the officer device information from the at least one searchable law enforcement database.

10. The method of claim 9 further comprising posting information relevant to law enforcement on the web-site.

11. The method of claim 9 further comprising accessing a vehicle concealment database at the web-site.

12. The method of claim 9 further comprising accessing a display of law enforcement related case law at the web-site.

13. The method of claim 9 further comprising accessing a law enforcement bulletins at the web-site.

14. The method of claim 9 further comprising accessing a member directory at the web-site.

15. A method for exchanging law enforcement related information comprising:
providing a web-site hosted on a notification server;
facilitating networked communication between the notification server, a plurality of officer devices, and a plurality of agency devices;
wherein the plurality of agency devices belong to at least two different agencies, each of which has at least one searchable law enforcement database;
facilitating accessing on the officer device a web-site hosted on the notification server;
facilitating inputting of information at the web-site, utilizing the officer device, regarding a seizure;
facilitating selection of at least two agencies to whom the information is to be communicated from the notification server to the agency devices in networked communication with the notification server;
facilitating receipt on the officer device of information from the at least one searchable law enforcement database.

16. The method of claim 15 further comprising facilitating access to a vehicle concealment database at the web-site.

17. The method of claim 15 further comprising facilitating access to a display of law enforcement related case law at the web-site.

18. The method of claim 15 further comprising facilitating access to a law enforcement bulletins at the web-site.

19. The method of claim 15 further comprising facilitating access to a member directory at the web-site.

20. The method of claim 15 wherein the web-site has at least one area of restricted access.
